(19) United States
(12) Patent Application Publication
(10) Pub. No.: US 2024/0334379 A1
(43) Pub. Date: Oct. 3, 2024

(54) CARRIER PHASE-BASED POSITIONING IN WIRELESS COMMUNICATION NETWORKS

(71) Applicant: ZTE Corporation, Shenzhen (CN)

(72) Inventors: Cong WANG, Shenzhen (CN); Chuangxin JIANG, Shenzhen (CN); Focai PENG, Shenzhen (CN); Juan LIU, Shenzhen (CN); Mengzhen LI, Shenzhen (CN); Qi YANG, Shenzhen (CN)

(21) Appl. No.: 18/743,676

(22) Filed: Jun. 14, 2024

Related U.S. Application Data
(63) Continuation of application No. PCT/CN2022/122948, filed on Sep. 29, 2022.

(51) Int. Cl. H04W 64/00; H04L 5/00

(52) U.S. Cl. CPC H04W 64/00; H04L 5/0051; H04L 5/0092

(57) ABSTRACT

Methods, devices, and systems for using carrier phase-based positioning to improve existing positioning techniques (e.g., time-difference-of-arrival, angle-of-arrival, angle-of-departure, multiple round-trip time, etc.) in wireless communication systems are described. An example method for wireless communication includes receiving, by a wireless device from a network node, a position reference signal, measuring one or more parameters of the position reference signal, and transmitting a report comprising the one or more parameters. Another example method for wireless communication includes transmitting, by a network node to a wireless device, a position reference signal, and receiving, from the wireless device, a report comprising one or more parameters of the position reference signal.

### CROSS REFERENCE TO RELATED APPLICATIONS

This patent document is a continuation of and claims benefit of priority to International Patent Application No. PCT/CN2022/122948, filed on Sep. 29, 2022. The entire content of the before-mentioned patent application is incorporated by reference as part of the disclosure of this application.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for using carrier phase-based positioning to improve existing positioning techniques in wireless communication systems. In an example, this is achieved by collecting phase information associated with subcarriers and/or physical resource blocks (PRBs) in different timeslots that carry a positioning reference signal (PRS), and using the measured and/or reported phase information to improve the positioning performance of time-difference-of-arrival (TDOA), angle-of-arrival (AOA), angle-of-departure (AOD), multiple round-trip time (multi-RTT), and other positioning methods. In another example, the disclosed embodiments may be used to identify other possible positioning error sources.

In an example aspect, a method for wireless communication includes receiving, by a wireless device from a network node, a position reference signal, measuring one or more parameters of the position reference signal, and transmitting a report comprising the one or more parameters.

In another example aspect, a method for wireless communication includes transmitting, by a network node to a wireless device, a position reference signal, and receiving, from the wireless device, a report comprising one or more parameters of the position reference signal.

In yet another example aspect, the above-described methods are embodied in the form of processor-executable code and stored in a non-transitory computer-readable storage medium. The code included in the computer readable storage medium when executed by a processor, causes the processor to implement the methods described in this patent document.

In yet another example embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows an example of a carrier phase positioning scenario.

FIG. 2 shows an example of carrier phase positioning in a system with a positioning reference unit (PRU).

FIG. 3 shows an example of grouping subcarriers that carry a positioning reference signal (PRS).

FIG. 4 shows an example of discarding phase measurements from subcarrier groups.

FIG. 5 shows an example of a phase change in a positioning signal.

FIG. 6 shows an example of carrier phase assisted measurement of angle-of-arrival.

FIGS. 7-9 show examples of the influence of angle-of-arrival (AOA) uncertainty on the positioning process.

FIG. 10 shows an example of different phases on different carrier frequencies.

FIG. 11 shows an example of uncertainty in a same subcarrier phase group (SCPG).

FIG. 12 shows an example of uncertainty in a same slot phase group (SSPG).

FIGS. 13 and 14 show examples flowchart for wireless communication.

FIG. 15 shows an example block diagram of a hardware platform that may be a part of a network device or a communication device.

FIG. 16 shows an example of wireless communication including a base station (BS) and user equipment (UE) based on some implementations of the disclosed technology.

### DETAILED DESCRIPTION

In recent years, many positioning technologies have been proposed in Fifth Generation (5G)-enabled network to achieve high accuracy positioning for a wireless device (e.g., UE, user terminal, target device) with the help of network node (e.g., gNB, base station), a location management function (LMF) or a positioning reference unit (PRU, which is fixed equipment whose location is known to the gNB/LFM). However, with the increasing positioning accuracy requirements of different application scenarios, existing positioning techniques cannot meet the growing demand. Embodiments of the disclosed technology are directed to improving the positioning accuracy by, for example, leveraging carrier phase positioning (CPP) technology as an auxiliary tool to ameliorate current positioning technology.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### 1. Overview of Carrier Phase-Based Positioning Methods

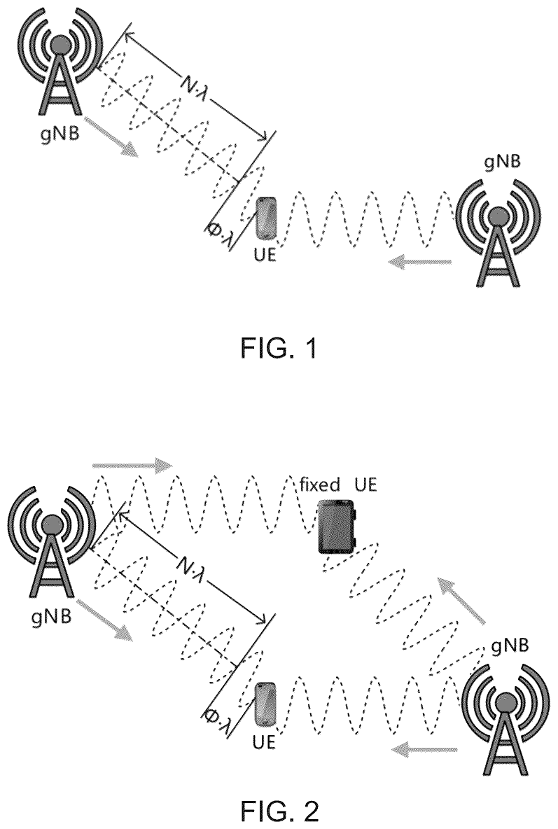

FIG. 1 shows an example of a carrier phase positioning scenario. As shown therein, the UE (e.g., wireless device, target device) receives a signal from the gNB (e.g., network node, base station) that is given by:

$$[ N + ϕ / ( 2 π ) ] λ = D + w \qquad ( 1 )$$

Herein, λ=c/f is the wavelength of the radio signal (c is the speed of light, f is the carrier frequency of the radio wave transmitted by the transmitter), N is the integer part of carrier phase (the number of full wavelengths experienced between the transmitter and the receiver), ϕ is the carrier phase, ϕ/(2π) denotes the fractional part of carrier phase, D is the distance between UE and gNB (line-of-sight (LOS) distance), and w is measurement noise.

FIG. 2 shows an example of carrier phase positioning in a system with a positioning reference unit (PRU), which enables a more accurate determination of the carrier phase and subsequent positioning estimate. In some embodiment, for each pair of gNB and UE, the relationship between the measurement distance and the carrier phase is given by Eqn. (1). In other embodiments, double the phase difference between different UE and gNB are leveraged to alleviate or eliminate the side effects of measurement error, further achieving better positioning performance.

### 2. Embodiments Directed to Grouping and Filtering Carriers

In some embodiments, the position reference signal (PRS) can be configured with a large transmission bandwidth, and the transmission resources for the PRS can be divided into multiple subcarriers. For example, if the dedicated bandwidth is configured with a subcarrier spacing (SCS) of 30 kHz, the wavelength of each subcarrier will be slightly different. Specifically, in this example, the wavelength of i-th sub-carrier is λⁱ=c/(f_{c}+Δf·i) (Δf=30 kHz) such that a larger value of i will result in the wavelength of the corresponding sub-carrier being shorter. Therefore, the corresponding phases measured by the receiver at different subcarriers will also be different. Since phase determination is usually subject to measurement errors, the accuracy of positioning methods may not be satisfactory for certain applications if the LMF is configured to use the phase of a single subcarrier to calculate the position of the corresponding UE. Embodiments of the disclosed technology mitigate this possible loss in accuracy by using several subcarriers as a group to determine the carrier phase.

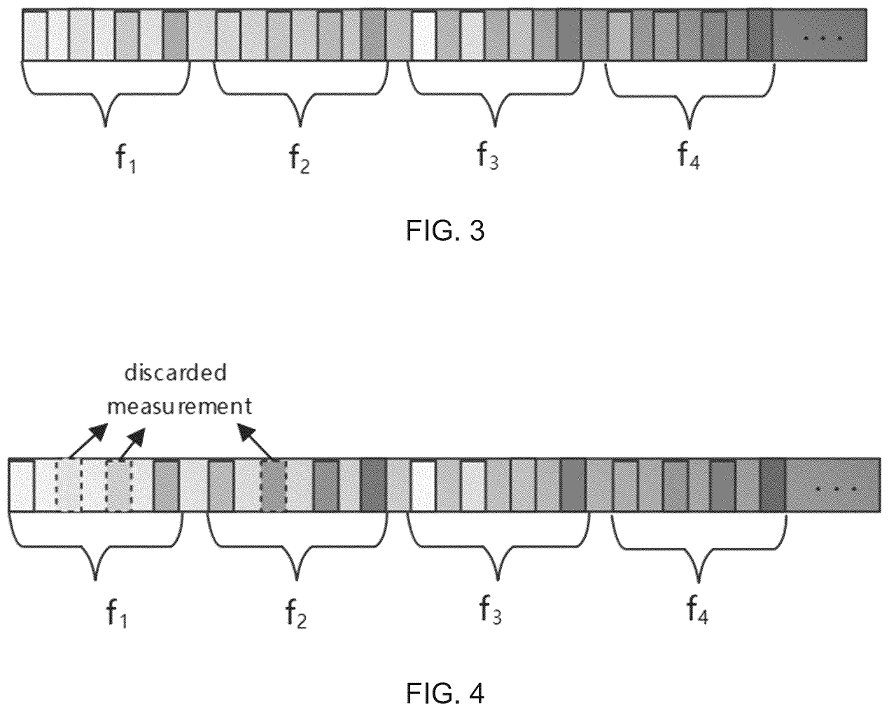

As shown in FIG. 3, in a given bandwidth resource, subcarriers can be configured to carry corresponding PRS signals. In another example, physical resource blocks (PRBs) can be configured to carry the corresponding PRS signals. In these scenarios, the target device is configured to determine the carrier frequency and received carrier phase for every N (e.g., N=4) subcarriers or PRBs that carry the PRS. In some embodiments, the LMF can configure the threshold of PRBs and/or the subcarrier numbers for each group.

In the context of FIG. 3, f₁, f₂, . . . denote the average frequency corresponding to the grouped subcarriers and ϕ₁, ϕ₂, . . . represent the corresponding phase of each group. In an example, the number of subcarriers in each group is identical. In another example, the number of subcarriers in each group can be different.

Taking f₁, f₂ and ϕ₁, ϕ₂ as an example, Eqn. (1) can be expressed as:

$$( {N}_{1} + {ϕ}_{1} / ( 2 π ) ) c = ( D + w ) {f}_{1} \qquad ( 2 )$$

$$( {N}_{2} + {ϕ}_{2} / ( 2 π ) ) c = ( D + w ) {f}_{2} \qquad ( 3 )$$

Herein, N₁, N₂ are the integer part of carrier phase group f₁, f₂, i.e., the number of full wavelengths experienced between the transmitter and the receiver, ϕ₁/(2π) and ϕ₂/(2π) denote the fractional part of carrier phase of f₁ and f₂, respectively, c is the speed of light, D is the distance between UE and gNB (the line-of-sight (LOS) distance), and w is measurement noise.

The difference between Eqns. (2) and (3), i.e., (3)-(2), is determined as:

$$( {N}_{2} - {N}_{1} ) c + ( {ϕ}_{2} - {ϕ}_{1} ) / ( 2 π ) c = ( D + w ) ( {f}_{2} - {f}_{1} ) \qquad ( 4 )$$

This can be expressed as:

$$\frac{Δ N * c + Δϕ / ( 2 π ) * c}{Δ f} = D + w \qquad ( 5 )$$

Herein, ΔN=N₂−N₁ denotes the difference between integer wavelengths corresponding to the propagation distance of the two subcarriers, Δϕ=ϕ₂−ϕ₁ is the phase difference of f₁ and f₂, and Δf=f₂−f₁ is the frequency difference. Because the measurement error of carrier phase on UE side may vary, the LMF can be configured to discard a reported phase that deviates significantly (e.g., with a difference larger than a predetermined threshold) from the expected phase, as shown in FIG. 4. Alternatively, the UE can report the carrier phase of all the subcarriers that carry the PRS in ascending (or descending) order of frequency. In the latter scenario, the LMF can efficiently to screen out phases with large difference from the expected phase.

In some embodiments, a more accurate estimate of the distance is obtained by determining the value of ΔN. An efficient approach typically searches for a specific value of ΔN within a specific search range, e.g., [ΔN−M,ΔN+M]. Embodiments of the disclosed technology are configured to trade-off the computational complexity and distance estimation accuracy, e.g., a larger M can improve the positioning accuracy, but results in higher computational complexity.

In an example, and based on Eqns. (2) and (3), the integer parts of each subcarrier can be determined as:

$${N}_{1} = ⌊ \frac{D + w}{{λ}_{1}} ⌋ \qquad ( 6 )$$

$${N}_{2} = ⌊ \frac{D + w}{{λ}_{2}} ⌋ \qquad ( 7 )$$

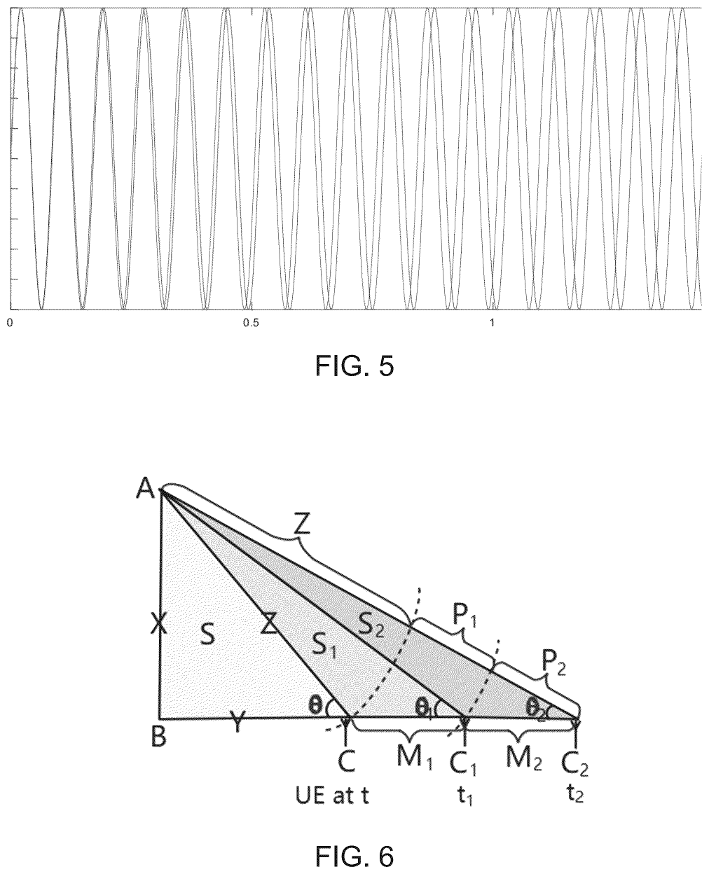

FIG. 5 shows an example of the phase difference of signals transmitted from the gNB with the same initial phase and different subcarrier frequencies. As seen in FIG. 5, Eqn. (6) and Eqn. (7), ΔN is a function of at least three factors: the distance between gNB and UE (D), frequency difference (Δf) and carrier frequency band.

In some embodiments, the search window for ΔN, e.g., [ΔN−M,ΔN+M] can be determined using the aforementioned parameters. In an example, ΔN₁₂=N₂−N₁ can be used to determine the integer range such that the search window for ΔN₁₂ is [ΔN₁₂−ΔN₁₂·X, ΔN₁₂+ΔN₁₂·X], where X can be determined by the specific application scenario or positioning accuracy requirements. In these embodiment, the LMF can determine the range of the integer search window based on a percentage of ΔNᵢⱼ (where i, j are two adjacent sub-carrier groups), which is a function of the phase difference of two subcarrier groups. In some embodiment, any two pairs of groups of subcarriers (e.g., adjacent or non-adjacent groups) may be used to determine the search window range.

In other embodiments, the UE can determine the number of subcarriers for each group autonomously, and discard the reported phases with large difference from the expected phase on the UE side.

In yet other embodiments, UE can report the average carrier phase for each group, instead of each resource. Reporting the average carrier phase for each group reduces the bandwidth and energy requirements of the reporting messages.

In some embodiments, the described method may further reduce the search range of the integer part of the carrier phase by differentiating between the integer parts of different carriers. In other embodiments, the accuracy of the phase determination can be effectively improved by screening the phase measurement values.

In some embodiments, grouping and filtering carriers (e.g., described in this section) may be performed in conjunction determining the carrier phase uncertainty in different timeslots (e.g., as described in Section 7).

### 3. Embodiments Directed to Carrier Phase in Different Timeslots

In some embodiments, the angle-of-arrival (AOA) of single antenna UE can be determined using the carrier phase. FIG. 6 shows that the evolving location of the UE as a function of time, and as shown therein, the UE is at C at time t, at C₁ at time t₁, and at C₂ at time t₂, with A representing the location of the gNB. The UE is configured to measure its carrier phase difference at time t₁ and t₂, e.g., Δϕ₁ (carrier difference between time t₁ and t) and Δϕ₂ (carrier difference between time t₂ and t₁). In an example, the LMF can configure the threshold of t₁ and t₂ for carrier phase assisted AOA reporting. In this embodiment, if the time difference is short enough, especially when AC₁−AC<λ or AC₂−AC₁<λ, a small phase measurement error will have a great impact on angle reporting.

In FIG. 6, P₁=Δϕ₁/(2π)·λ represents the distance difference between the UE and the base station between times t₁ and t, P₂=Δϕ₂/(2π)·λ represents the distance difference between the UE and the base station between times t₂ and t₁, M₁=v·(t₂−t₁), M₂=v·(t₁−t₀) represents the distance that UE moves in [t, t₁] and [t₁, t₂], Y is the horizontal distance between gNB and UE (at time t, the motion direction of the UE is assumed as horizontal), X is the vertical distance between gNB and UE, and Z is the distance between gNB and UE.

In this embodiment, the AOA can be determined using the following calculations:

$$cos θ = Y / Z \qquad ( 8 )$$

$$cos {θ}_{1} = ( Y + {M}_{1} ) / ( Z + {P}_{1} ) \qquad ( 9 )$$

$$cos {θ}_{2} = ( Y + {M}_{1} + {M}_{2} ) / ( Z + {P}_{1} + {P}_{2} ) \qquad ( 10 )$$

Eqns. (8), (9) and (10) can be rewritten as:

$${θ}_{1} = arccos [ ( Z \cdot cos θ + {M}_{1} ) / ( Z + {P}_{1} ) ] \qquad ( 11 )$$

$$or cos {θ}_{1} = ( Z \cdot cos θ + {M}_{1} ) / ( Z + {P}_{1} ) \qquad ( 11 a )$$

$${θ}_{2} = arccos [ ( Z \cdot cos θ + {M}_{1} + {M}_{2} ) / ( Z + {P}_{1} + {P}_{2} ) ] \qquad ( 12 )$$

$$or cos {θ}_{2} = ( Z \cdot cos θ + {M}_{1} + {M}_{2} ) / ( Z + {P}_{1} + {P}_{2} ) \qquad ( 12 a )$$

Eqns. (11), (11a), (12) and (12a) provide the initial set of calculations needed to determine the AOA, and can be further developed by leveraging the relationship between angle and phase based on the movement of the UE.

In FIG. 6, let S₀ denote the area of ΔABC, S₁ represent the area of ΔACC₁, and S₂ represent the area of ΔAC₁C₂. These areas can be determined as:

$${S}_{0} = 1 / 2 \cdot Y \cdot Z \cdot sin θ \qquad ( 13 )$$

$${S}_{1} = 1 / 2 \cdot {M}_{1} \cdot ( Z + {P}_{1} ) \cdot sin {θ}_{1} \qquad ( 14 )$$

$${S}_{2} = 1 / 2 \cdot {M}_{2} \cdot ( Z + {P}_{1} + {P}_{2} ) \cdot sin {θ}_{2} \qquad ( 15 )$$

Furthermore, the following areas may be determined:

The area of ΔABC₁ is

$$1 / 2 \cdot ( Y + {M}_{1} ) \cdot ( Z + {P}_{1} ) \cdot sin {θ}_{1} \qquad ( 15 )$$

The area of ΔACC₂ is

$$1 / 2 \cdot ( {M}_{1} + {M}_{2} ) \cdot ( Z + {P}_{1} + {P}_{2} ) \cdot sin {θ}_{2} \qquad ( 17 )$$

The area of ΔABC₁ equals S₀+S₁, and is given as:

$$( Y + {M}_{1} ) \cdot ( Z + {P}_{1} ) \cdot sin {θ}_{1} = Y \cdot Z \cdot sin θ + {M}_{1} \cdot ( Z + {P}_{1} ) \cdot sin {θ}_{1} \qquad ( 18 )$$

The area of ΔACC₂ equals S₂+S₁, and is given as:

$$( {M}_{1} + {M}_{2} ) \cdot ( Z + {P}_{1} + {P}_{2} ) \cdot sin {θ}_{2} = {M}_{1} \cdot ( Z + {P}_{1} ) \cdot sin {θ}_{1} + {M}_{1} \cdot ( Z + {P}_{1} + {P}_{2} ) \cdot sin {θ}_{2} \qquad ( 19 )$$

Using the above area calculation results, the following angles are determined as:

$$θ = arcsin [ ( Z + {P}_{1} ) \cdot sin {θ}_{1} / Z ] \qquad ( 20 )$$

$$or$$

$$sin θ = ( Z + {P}_{1} ) \cdot sin {θ}_{1} / Z \qquad ( 20 a )$$

$${θ}_{1} = arcsin \{ {M}_{2} ( Z + {P}_{1} + {P}_{2} ) \cdot sin {θ}_{2} / [ {M}_{1} ( Z + {P}_{1} ) ] \} \qquad ( 21 )$$

$$or$$

$$sin {θ}_{1} = {M}_{2} ( Z + {P}_{1} + {P}_{2} ) \cdot sin {θ}_{2} / [ {M}_{1} ( Z + {P}_{1} ) ] \qquad ( 21 a )$$

The angle-of-arrival (AOA) can be determined based on Eqns. (11), (12), (20) and (21), and can be reported by the UE. Alternatively, UE can report the phase related information of the expected time slot to the network (e.g., LMF).

This embodiment can advantageously enable a single-antenna UE to accurately determine the AOA using only the UE's movement and received carrier phase, and can be used to improve existing positioning techniques.

In some embodiments, grouping and filtering carriers (e.g., described in Section 2) can be used to determine P₁ and/or P₂.

In some embodiments, determining the carrier phase using multiple carriers (e.g., described in Section 6) can be used to provide better estimate of range between gNB and UE.

### 4. Embodiments Directed to Carrier Phase in TDOA

In some embodiments, and as part of existing positioning implementations, the target device is configured to send a ProvideLocationInformation message to the server to transfer location information at part of the LTE positioning protocol (LPP). The corresponding message in the Observed Time-Difference-of-Arrival (OTDOA) Location Information Elements includes a field that specifies the OTDOA measurement quality, which is denoted OTDOA-MeasQuality.

In some implementations, OTDOA-MeasQuality includes three elements:
error-Resolution: specifies the resolution used in error-Value field;
error-Value: specifies the target device's best estimate of the uncertainty of the OTDOA (or TOA) measurement (unit: m); and
error-NumSamples (optional): provides the sample uncertainty of the OTDOA (or TOA) measurement, this field specifies how many measurements have been used by the target device to determine this (e.g., sample size).

Embodiments of the disclosed technology are configured to define the relationship between the scope of integer for CPP and the OTDOA uncertainty. In some embodiments, the integer part of the carrier phase is searched within the uncertainty range R, which is based on the uncertainty reported by the target device, e.g.

$$[ min \{ 0 , {N}_{c} - ⌈ \frac{R}{2 λ} ⌉ \} , {N}_{c} + ⌈ \frac{R}{2 λ} ⌉ ] . \qquad ( 22 )$$

In some embodiments, determining the carrier phase in TDOA (e.g., described in this section) can be performed in conjunction with grouping and filtering carriers (e.g., described in Section 2) to determine the integer part of the carrier phase.

### 5. Embodiments Directed to Carrier Phase in AOA/AOD

In some embodiments, and as part of existing positioning implementations, the NR-DL-PRS-AssistanceData message includes a field named as nr-DL-PRS-ExpectedAoD-or-AoA, which specifies the expected AoD or AoA at the target device location together with uncertainty. Embodiments of the disclosed technology are configured to define the relationship between the scope of integer for CPP and the AOA/AOD uncertainty.

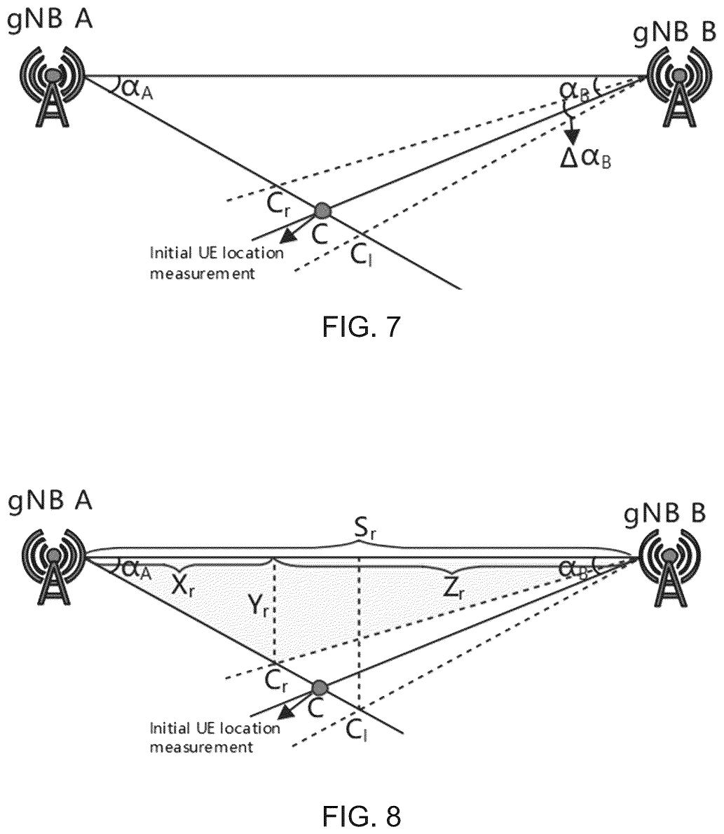

FIGS. 7-9 show examples of the influence of angle-of-arrival (AOA) uncertainty on the positioning process. Although this example is directed to the computation of the AOA, the AOD may be similarly computed. In this example, Cᵣ and Cₗ are the limits of the UE locations measured using the uncertainty of gNB B's AOA.

FIG. 7 shows gNB A and gNB B being two transmission-reception points (TRPs) that send a downlink (DL) PRS to the target UE. Here, α_{A} and α_{B} are the expected AOA/AOD values, which can be converted from the reported azimuth angle, e.g., expected-DL-Azimuth-AOA or expected-DL-Azimuth-AOD, and C is the UE location measured using A and B's AOA and/or AOD.

FIG. 8 shows Cᵣ being the UE location measured using A's AOA (α_{A}, i.e., ∠BAC) and the lower limit gNB B's AOA (α_{B}−Δα_{B}/2, i.e., ∠ABCᵣ), where Δα_{B}, i.e., ∠CₗBCᵣ, is the uncertainty of gNB B's AOA, i.e., expected-DL-Azimuth-AOA-Unc. In the shaded triangle ABCᵣ, it can be determined:

$$\{ \begin{matrix}tan ( {α}_{B} - Δ {α}_{B} / 2 ) = {Y}_{r} / {Z}_{r} \\ tan {α}_{A} = {Y}_{r} / {X}_{r} \\ {X}_{r} + {Z}_{r} = {S}_{r}\end{matrix} \qquad ( 23 )$$

Eqn. (23) can be solved to determine the value of Yᵣ, and the distance between A and Cᵣ is determined as:

$${AC}_{r} = {Y}_{r} / sin {α}_{A} \qquad ( 24 )$$

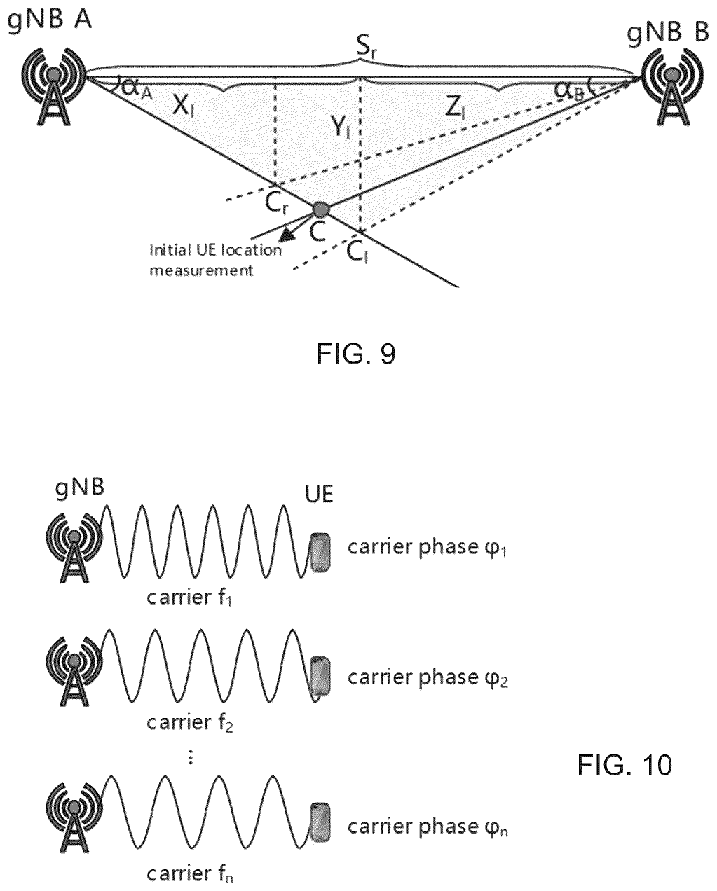

Similarly, and for the shaded triangle ABCₗ in FIG. 9, it can be determined:

$$\{ \begin{matrix}tan ( {α}_{B} + Δ {α}_{B} / 2 ) = {Y}_{l} / {Z}_{l} \\ tan {α}_{A} = {Y}_{l} / {X}_{l} \\ {X}_{l} + {Z}_{l} = {S}_{r}\end{matrix} \qquad ( 25 )$$

Eqn. (25) can be solved to determine the value of Yₗ, and the distance between A and Cₗ is determined as:

$${AC}_{l} = {Y}_{l} / sin {α}_{A} \qquad ( 26 )$$

In some embodiments, the position difference calculated by measurement uncertainty equals to the distance between Cₗ and Cᵣ, defined as Δd=CₗCᵣ=ACₗ−ACᵣ, and the scope of integer can be calculated as:

$$[ min \{ 0 , {N}_{c} - ⌈ \frac{Δ d}{2 λ} ⌉ \} , {N}_{c} + ⌈ \frac{Δ d}{2 λ} ⌉ ] \qquad ( 27 )$$

In some embodiments, the integer part of carrier transmitted between A and C can be used as the center of the search window, and defining Δdᵣ=CCᵣ=AC−ACᵣ, Δdₗ=CCₗ=ACₗ−AC, results in the scope of integer being calculated as:

$$[ min \{ 0 , {N}_{{c}^{-}} ⌈ \frac{Δ {d}_{r}}{λ} ⌉ \} , {N}_{c} + ⌈ \frac{Δ {d}_{l}}{λ} ⌉ ] \qquad ( 28 )$$

Herein, N_{c} is the integer part used for the estimation of AC.

In some embodiments, determining the carrier phase in AOA/AOD (e.g., described in this section) can be performed in conjunction with grouping and filtering carriers (e.g., described in Section 2) to determine the integer part of the carrier phase.

### 6. Embodiments Directed to Carrier Phase in Multiple Carriers

In some embodiments, multiple PRS may be transmitted between the same TRP and the target device pair with different carriers in a positioning process. As shown in FIG. 10, gNB transmits the corresponding positioning signal with different carrier frequency, f₁, f₂, . . . , fₙ, and the carrier phase received on UE side is typically different for each carrier.

From Eqn. (2), it can be determined:

$${ϕ}_{1} / ( 2 π ) = ⌊ ( D + w ) {f}_{1} / c ⌋ \qquad ( 29 )$$

This computation motivates the target device to report the carrier phase with its corresponding uncertainty for each of the different carrier frequencies to the LMF, which is configured to evaluate the likelihood of the positioning result. It is noted the initial transmission phase of the PRS may also vary with the transmission antenna, carrier frequency, and/or beam selection. In this scenario, the gNB can specify the initial transmission phase of PRS to achieve the calibration of carrier phase on gNB side.

In the context of FIG. 10, denote ϕ₁, ϕ₂, . . . , ϕₙ as the phase of carrier frequency f₁, f₂, . . . , fₙ, respectively, and Δϕ₁, Δϕ₂, . . . , Δϕₙ as the carrier phase uncertainty. Herein, the distance between gNB and UE should be located within the range:

$$[ ( {N}_{i} + {ϕ}_{{i}^{-}} Δ {ϕ}_{i} / 2 - {Ψ}_{i} ) c / {f}_{i} , ( {N}_{i} + {ϕ}_{i} + Δ {ϕ}_{i} / 2 - {Ψ}_{i} ) c / {f}_{i} ] \qquad ( 30 )$$

Herein, i ranges from 1 to n, and Ψᵢ is the initial transmission phase (reported by gNB) of carrier frequency fᵢ. If the positioning result shows that the distance between the gNB and target device does not lie in the above interval, it means that there is a certain deviation in positioning, and the result should be corrected.

In some embodiments, deriving positioning results (e.g., as described in this section) can be performed in conjunction with grouping and filtering carriers (e.g., described in Section 2) to determine the carrier phases.

### 7. Embodiments Directed to Carrier Phase Uncertainty in Different Timeslots

In some embodiments, multiple PRS may be transmitted between the same TRP and the target device pair in different transmission timeslots with the same subcarrier in a positioning process. Herein, the set of carrier phases is defined as a Same sub-Carrier Phase Group (SCPG).

However, in practical implementations, the carrier phase will change with the channel environment and UE's movement. Therefore, the network (e.g., LMF) may configure the time duration for each SCPG.

For each SCPG, the carrier phase range in slot tⱼ can be expressed as:

$$[ {ϕ}_{j}^{t} - Δ {ϕ}_{j}^{t} / 2 , {ϕ}_{j}^{t} + Δ {ϕ}_{j}^{t} / 2 ] \qquad ( 31 )$$

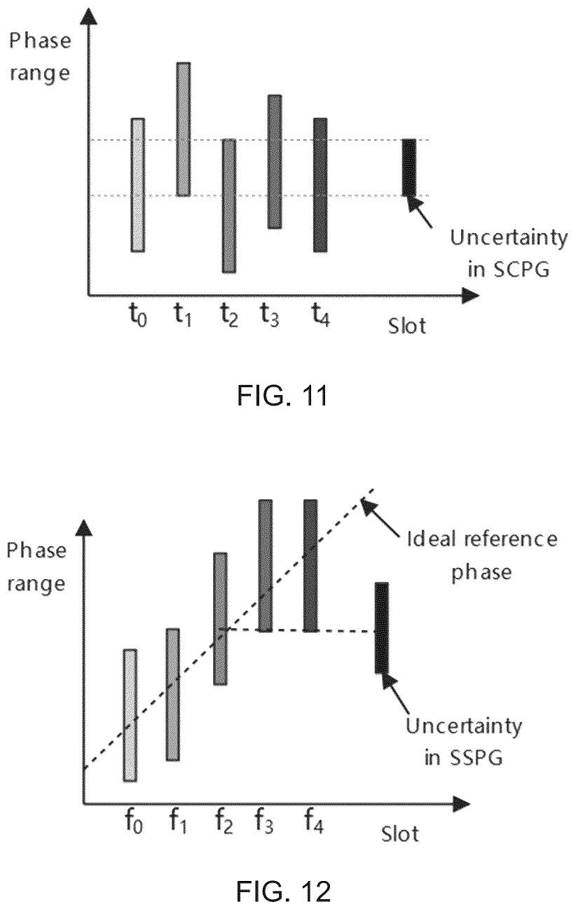

Herein, ϕⱼ^{t} is the phase of carrier frequency in slot tⱼ, and Δϕⱼ^{t} represents the carrier phase uncertainty. As shown in FIG. 11, finding the intersection of the phase ranges at different times can effectively smooth the phase uncertainty on UE side. The phase uncertainty in a SCPG can be determined as:

$$[ {ϕ}_{min}^{t} , {ϕ}_{max}^{t} ] = ⋂ [ {ϕ}_{j}^{t} - Δ {ϕ}_{j}^{t} / 2 , {ϕ}_{j}^{t} + Δ {ϕ}_{j}^{t} / 2 ] \qquad ( 32 )$$

Herein, the phase range in SCPG is [ϕₘᵢₙ^{t}, ϕₘₐₓ^{t}], and the positioning error (unit: m, wherein the positioning error refers to the distance corresponding to the phase uncertainty gap) caused by the phase uncertainty can be determined as:

$${ε}_{ϕ} = ( {ϕ}_{max}^{t} - {ϕ}_{min}^{t} ) / ( 2 π ) \cdot λ \qquad ( 33 )$$

In some embodiments, the target device can report the positioning error caused by the phase uncertainty in each SCPG.

### 8. Embodiments Directed to Carrier Phase Uncertainty in Different Subcarriers

In some embodiments, multiple PRS may be transmitted between the same TRP and the target device pair with different subcarriers in the same transmission slot in a positioning process. Herein, the set of carrier phase is defined as the Same Slot Phase Group (SSPG).

For each SSPG, the carrier phase range in sub-carrier fᵢ can be expressed as:

$$[ {ϕ}_{i}^{f} - Δ {ϕ}_{i}^{f} / 2 , {ϕ}_{i}^{f} + Δ {ϕ}_{i}^{f} / 2 ] \qquad ( 34 )$$

Herein, ϕᵢ^{f} is the phase of carrier frequency of fᵢ, and Δϕᵢ^{f} represents the carrier phase uncertainty. As shown in FIG. 12, finding the average of the phase ranges at different carrier can effectively smooth the uncertainty on UE side. The phase uncertainty in an SSPG can be determined by first calculating the center phase of the SSPG as:

$${ϕ}_{ave} = {\sum }_{i = 0}^{i = n} {ϕ}_{i}^{f} / n \qquad ( 35 )$$

And subsequently, determining the phase uncertainty of SSPG as:

$$Δ {ϕ}_{ave} = {\sum }_{i = 0}^{i = n} Δ {ϕ}_{i}^{f} / n \qquad ( 36 )$$

Herein, the possible phase range in SSPG is [ϕₐᵥₑ−Δϕₐᵥₑ/2, ϕₐᵥₑ+Δϕₐᵥₑ/2], and the positioning error (unit: m, wherein the positioning error refers to the distance corresponding to the phase uncertainty gap) caused by the phase uncertainty can be determined as:

$${ε}_{ϕ} = Δ {ϕ}_{ave} / ( 2 π ) \cdot λ \qquad ( 37 )$$

In some embodiments, the target device can report the positioning error caused by the phase uncertainty in each SSPG.

### 9. Example Embodiments and Implementations of the Disclosed Technology

Embodiments of the disclosed technology provide technical solutions to determine the integer part of the carrier phase (e.g., as described in Sections 2, 4 and 5), calculate the AOA given the carrier phase at different timeslots (e.g., as described in Section 3), provide calibration methods using the phase relationship between different carriers (e.g., as described in Section 6), and provide relationships between the reported phase uncertainty and the corresponding position error in different phase groups (e.g., as described in Sections 7 and 8). These embodiments solve the technical problem of existing positioning techniques not being accurate enough for different application scenarios in current and emerging wireless communication networks.

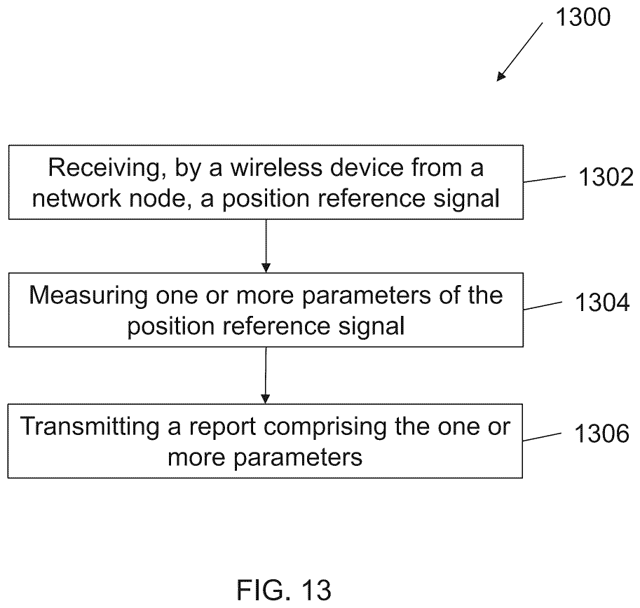

FIG. 13 shows an example flowchart for wireless communication. The method 1300 includes receiving, by a wireless device from a network node, a position reference signal (1302), measuring one or more parameters of the position reference signal (1304), and transmitting a report comprising the one or more parameters (1306).

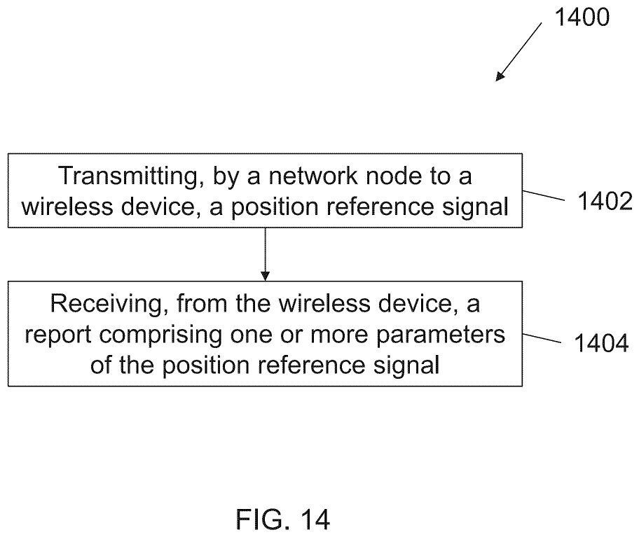

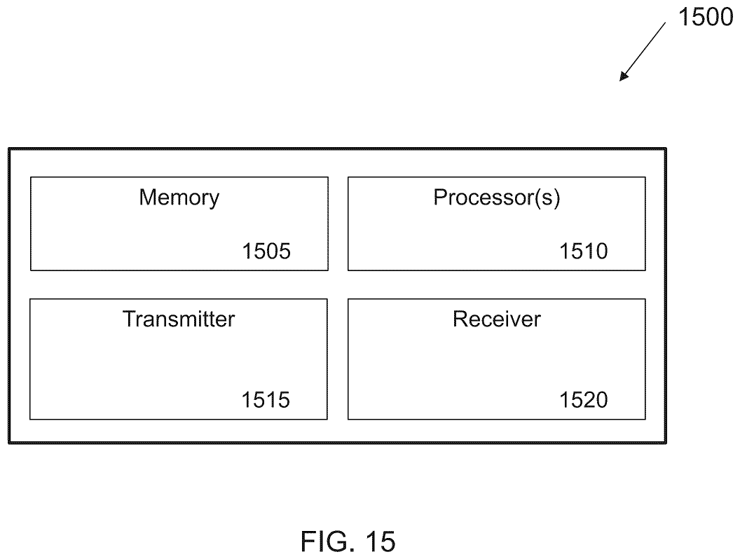

FIG. 14 shows an example flowchart for wireless communication. The method 1400 includes transmitting, by a network node to a wireless device, a position reference signal (1402), and receiving, from the wireless device, a report comprising one or more parameters of the position reference signal (1404).

Embodiments of the disclosed technology provide, inter alia, the following technical solutions that advantageously improve positioning systems in wireless communication.

A1. A method for positioning performed by a target device that includes (1) signal reception, e.g., receiving the positioning-related configuration signals and positioning reference signal (PRS), (2) signal measurement, e.g., measuring the positioning-related reference signals, and (3) measurement reporting, e.g., reporting the measurement result of positioning-related reference signals.

A2. The method of solution A1, wherein the positioning-related configuration includes the threshold of PRBs/subcarrier numbers for each group that carries the positioning reference signal.

A3. The method of solution A1, wherein the measurement result of the positioning-related reference signal includes the carrier phase of all the subcarriers that carries PRS in order of frequency from low to high (or from high to low).

A4. The method of solution A1, wherein the positioning-related configuration includes the scope of the integer search window, e.g., percentage of ΔNᵢⱼ (where i,j are two adjacent sub-carrier groups), i.e., X, phase difference of two sub-carrier groups.

A5. The method of solution A1, wherein the measurement result of the positioning-related reference signals includes the carrier phase of different subcarriers with tolerable differences from the expected phase, or the average carrier phase for each sub-carrier group.

A6. The method of solution A1, wherein the positioning-related configuration includes the threshold of t₁ and t₂ (time of phase reporting) for carrier phase assisted AOA measurement.

A7. The method of solution A1, wherein the measurement result of the positioning-related reference signal includes the AOA calculated using Eqns. (11), (12), (20) and (21).

A8. The method of solution A1, wherein the measurement result of the positioning-related reference signal includes the phase related information of the expected slots.

A9. The method of solution A1, wherein a mapping between the scope of the integer for CPP and the OTDOA uncertainty (R, unit: m) is determined as:

$$[ min \{ 0 , {N}_{c} - ⌈ \frac{R}{2 λ} ⌉ \} , {N}_{c} + ⌈ \frac{R}{2 λ} ⌉ ] .$$

A10. The method of solution A1, wherein a mapping between the scope of the integer for CPP and the AOA/AOD uncertainty (Δα) is determined as:

$$\begin{matrix}Option 1 & \\ [ min \{ 0 , {N}_{c} - ⌈ \frac{Δ d}{2 λ} ⌉ \} , {N}_{c} + ⌈ \frac{Δ d}{2 λ} ⌉ ] & \end{matrix}$$

$$\begin{matrix}Option 2 & \\ [ min \{ 0 , {N}_{c} - ⌈ \frac{Δ {d}_{r}}{λ} ⌉ \} , {N}_{c} + ⌈ \frac{Δ {d}_{1}}{λ} ⌉ ] & \end{matrix}$$

where Δd, Δdᵣ and Δdₗ are calculated using the equations mentioned in the embodiments directed to carrier phase in AOA/AOD.

A11. The method of solution A1, wherein the positioning-related configuration includes the time duration limitation for each SCPG.

A12. The method of solution A1, wherein the measurement result of the positioning-related reference signals includes the carrier phase with corresponding uncertainty concerning different carrier frequency and time slot.

A13. The method of solution A1, wherein the measurement result of the positioning-related reference signal includes the initial transmission phase of PRS.

A14. The method of solution A1, wherein the measurement result of the positioning-related reference signal includes the positioning error (unit: m) caused by the phase uncertainty in a SCPG that is determined as:

$${ε}_{ϕ} = ( {ϕ}_{max}^{t} - {ϕ}_{min}^{t} ) / ( 2 π ) \cdot λ$$

A15. The method of solution A1, wherein the measurement result of the positioning-related reference signal includes the positioning error (unit: m) caused by the phase uncertainty in a SSPG that is determined as:

$${ε}_{ϕ} = Δ {ϕ}_{ave} / ( 2 π ) \cdot λ$$

A16. A method for positioning performed by a base station that includes (1) signal reception, e.g., receiving the positioning-related configuration signals, (2) signal measurement, e.g., measuring the positioning-related reference signals, and (3) measurement reporting, e.g., reporting measurement result of the positioning-related reference signals.

Embodiments of the disclosed technology further provide, inter alia, the following technical solutions that advantageously improve positioning systems in wireless communication.

B1. A method of wireless communication, comprising: receiving, by a wireless device from a network node, a position reference signal; measuring one or more parameters of the position reference signal; and transmitting a report comprising the one or more parameters.

B2. A method of wireless communication, comprising: transmitting, by a network node to a wireless device, a position reference signal; and receiving, from the wireless device, a report comprising one or more parameters of the position reference signal.

B3. The method of solution B2, further comprising: measuring, by the network node, a sounding reference signal; and transmitting a report comprising one or more parameters of the sounding reference signal.

B4. The method of any of solutions B1 to B3, further comprising: receiving, from a location management function, a positioning-related configuration signal.

B5. The method of any of solutions B1 to B4, wherein transmission resources of the position reference signal (PRS) comprise a plurality of physical resource blocks (PRBs) or a plurality of subcarriers, and wherein measuring the one or more parameters of the position reference signal (PRS) comprises: measuring a carrier phase of each of the plurality of PRBs or each of the plurality of subcarriers.

B6. The method of solution B5, wherein the plurality of PRBs or the plurality of subcarriers are divided into one or more groups of PRBs or one or more groups of subcarriers, respectively.

B7. The method of solution B6, wherein a threshold associated with each of the one or more groups of PRBs or a group number of each of the one or more groups of subcarriers is configured by a location management function (LMF).

B8. The method of solution B6, wherein the one or more parameters comprises the carrier phases for the plurality of PRBs or the plurality of subcarriers.

B9. The method of solution B8, wherein the carrier phases for the plurality of subcarriers are ordered based on a corresponding frequency of each of the plurality of subcarriers.

B10. The method of solution B9, wherein the carrier phases are ordered from a corresponding highest frequency to a corresponding lowest frequency.

B11. The method of solution B9, wherein the carrier phases are ordered from a corresponding lowest frequency to a corresponding highest frequency.

B12. The method of solution B8, wherein a location management function (LMF) is configured to discard one or more of the carrier phases that are different from an expected phase by a value greater than a threshold.

B13. The method of solution B6, wherein a group carrier phase of a group of PRBs or a group of subcarriers comprises an integer part and a fractional part.

B14. The method of solution B13, wherein a length of a search window for the integer part of the group carrier phase is based on a phase difference between adjacent groups of subcarriers.

B15. The method of solution B13, wherein the one or more parameters comprises an average carrier phase for each of the one or more groups of PRBs or the one or more groups of subcarriers.

B16. The method of any of solutions B1 to B4, wherein the wireless device is configured to determine a position of the wireless device based on an angle-of-arrival (AOA) of a signal that is measured at an antenna of the wireless device in multiple timeslots.

B17. The method of solution B16, wherein the wireless device is at a first position in a first timeslot of the multiple timeslots, a second position in a second timeslot of the multiple timeslots, and a third position in a third timeslot of the multiple timeslots, and wherein a maximum difference between (a) the second timeslot and the first timeslot or (b) the third timeslot and the second timeslot is configured by a location management function (LMF).

B18. The method of solution B17, wherein the wireless device is configured to determine a distance between the wireless device and the network node based on a carrier phase of the signal.

B19. The method of solution B17, wherein the AOA at the first position is θ₀, the AOA at the second position is θ₁, and the AOA at the third position is θ₂, wherein the angles-of-arrival are determined as:

$${θ}_{1} = arccos [ ( Z \cdot cos θ + {M}_{1} ) / ( Z + {P}_{1} ) ]$$

$${θ}_{2} = arccos [ ( Z \cdot cos θ + {M}_{1} + {M}_{2} ) / ( Z + {P}_{1} + {P}_{2} ) ]$$

$$θ = arcsin [ ( Z + {P}_{1} ) \cdot sin {θ}_{1} / Z ]$$

$${θ}_{1} = arcsin \{ {M}_{2} ( Z + {P}_{1} + {P}_{2} ) \cdot sin {θ}_{2} / [ {M}_{1} ( Z + {P}_{1} ) ] \}$$

In B19, P₁ is a distance difference between the wireless device and the network node between the first timeslot and the second timeslot, P₂ is a distance difference between the wireless device and the network node between the second timeslot and the third timeslot, M₁ is a distance between the first position and the second position, M₁+M₂ is a distance between the first position and the third position, and Z is a distance between the wireless device and the network node at the first position in the first timeslot.

B20. The method of solution B19, wherein M₁ is equal to M₂.

B21. The method of solution B19, wherein M₁ is not equal to M₂.

B22. The method of solution B17, wherein the one or more parameters comprises a carrier phase of the signal at the first location, the second location, or the third location.

B23. The method of any of solutions B1 to B4, wherein the wireless device is configured to determine a position of the wireless device based on an observed time difference of arrival (OTDOA) positioning framework.

B24. The method of solution B23, wherein the one or more parameters comprises a carrier phase of the PRS, and wherein the carrier phase comprises an integer part and a fractional part.

B25. The method of solution B24, wherein the wireless device is configured to transmit a location information message to the network node, and wherein the location information message comprises a range uncertainty of a measurement made using the OTDOA positioning framework.

B26. The method of solution B25, wherein the integer part (N_{c}) is determined as:

$$[ min \{ 0 , {N}_{c} - ⌈ \frac{R}{2 λ} ⌉ \} , {N}_{c} + ⌈ \frac{R}{2 λ} ⌉ ] ,$$

wherein R (unit: m) is a measurement uncertainty of the OTDOA positioning framework.

B27. The method of any of solutions B1 to B4, wherein the wireless device is configured to determine a position of the wireless device based on an angle-of-arrival (AOA) or an angle-of-departure (AOD) positioning framework.

B28. The method of solution B27, wherein the wireless device is configured to receive a position information message comprising an angular uncertainty associated with the AOA or the AOD positioning framework.

B29. The method of solution B28, wherein a carrier phase of the position information message comprises an integer part and a fractional part, and wherein the wireless device is configured to determine a distance uncertainty based on the angular uncertainty and a distance between the wireless device and the network node.

B30. The method of solution B29, wherein the integer part (N_{c}) is determined as:

$$[ min \{ 0 , {N}_{c} - ⌈ \frac{Δ d}{2 λ} ⌉ \} , {N}_{c} + ⌈ \frac{Δ d}{2 λ} ⌉ ] ,$$

wherein λ is a wavelength associated with the position information message, and Δd is distance uncertainty associated with the angular uncertainty.

B31. The method of solution B29, wherein the integer part (N_{c}) is determined as:

$$[ min \{ 0 , {N}_{c} - ⌈ \frac{Δ {d}_{r}}{λ} ⌉ \} , {N}_{c} + ⌈ \frac{Δ {d}_{l}}{λ} ⌉ ] ,$$

wherein λ is a wavelength associated with the position information message, and Δdᵣ and Δdₗ are distance uncertainties associated with the angular uncertainty on different sides.

B32. The method of any of solutions B1 to B4, wherein the position reference signal (PRS) is communicated on a plurality of carriers, each of the plurality of carriers being associated with corresponding carrier frequency.

B33. The method of solution B32, wherein the one or more parameters comprises a carrier phase and a corresponding uncertainty associated with each of the carrier frequencies.

B34. The method of solution B32 or B33, wherein the wireless device is configured to receive an initial transmission phase of the PRS on each of the plurality of carriers from the network node.

B35. The method of any of solutions B1 to B4, wherein the position reference signal (PRS) is communicated in a plurality of timeslots in a same subcarrier.

B36. The method of solution B35, wherein a same subcarrier phase group (SCPG) comprises each of a plurality of carrier phases for the same subcarrier in each of a corresponding timeslot of the plurality of timeslots.

B37. The method of solution B36, wherein a time duration of the SCPG is configured by a location management function (LMF).

B38. The method of solution B36 or B37, wherein the wireless device is configured to determine a maximum phase uncertainty (ϕₘₐₓ^{t}) and a minimum phase uncertainty (ϕₘᵢₙ^{t}) from a plurality of phase uncertainties associated with a corresponding carrier phase of the plurality of carrier phases.

B39. The method of solution B38, wherein the wireless device is further configured to determine a positioning error (ε_{ϕ}) as: ε_{ϕ}=(ϕₘₐₓ^{t}−ϕₘᵢₙ^{t})/(2π)·λ, wherein λ is a wavelength associated with the PRS, and wherein the one or more parameters comprises the positioning error.

B40. The method of any of solutions B1 to B4, wherein the position reference signal (PRS) is communicated in a plurality of subcarriers in a same timeslot.

B41. The method of solution B40, wherein a same slot phase group (SSPG)

comprises each of a plurality of carrier phases for a corresponding subcarrier of the plurality of subcarrier in the same timeslot.

B42. The method of solution B41, wherein the wireless device is configured to determine an average phase uncertainty (Δϕₐᵥₑ) for the plurality of carrier phases.

B43. The method of solution B42, wherein the wireless device is further configured to determine a positioning error (ε_{ϕ}) as: ε_{ϕ}=Δϕₐᵥₑ/(2π)·λ, wherein λ is a wavelength associated with the PRS, and wherein the one or more parameters comprises the positioning error.

B44. An apparatus for wireless communication comprising a processor, configured to implement a method recited in one or more of solutions B1 to B43.

B45. A non-transitory computer readable program storage medium having code stored thereon, the code, when executed by a processor, causing the processor to implement a method recited in one or more of solutions B1 to B43.

FIG. 15 shows an example block diagram of a hardware platform 1500 that may be a part of a network device (e.g., base station) or a communication device (e.g., a user equipment (UE)). The hardware platform 1500 includes at least one processor 1510 and a memory 1505 having instructions stored thereupon. The instructions upon execution by the processor 1510 configure the hardware platform 1500 to perform the operations described in FIGS. 13 and 14 and in the various embodiments described in this patent document. The transmitter 1515 transmits or sends information or data to another device. For example, a network device transmitter can send a message to a user equipment. The receiver 1520 receives information or data transmitted or sent by another device. For example, a user equipment can receive a message from a network device.

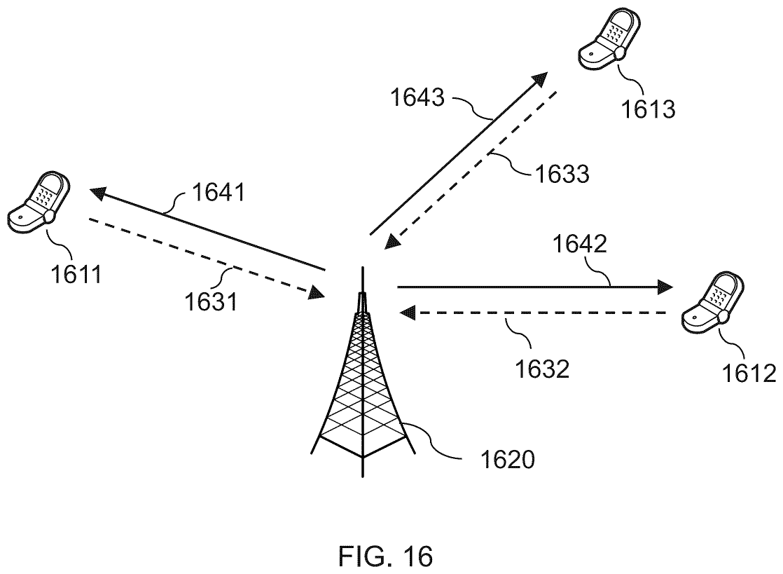

The implementations as discussed above will apply to a wireless communication. FIG. 16 shows an example of a wireless communication system (e.g., a 5G or NR cellular network) that includes a base station 1620 and one or more user equipment (UE) 1611, 1612 and 1613. In some embodiments, the UEs access the BS (e.g., the network) using a communication link to the network (sometimes called uplink direction, as depicted by dashed arrows 1631, 1632, 1633), which then enables subsequent communication (e.g., shown in the direction from the network to the UEs, sometimes called downlink direction, shown by arrows 1641, 1642, 1643) from the BS to the UEs. In some embodiments, the BS send information to the UEs (sometimes called downlink direction, as depicted by arrows 1641, 1642, 1643), which then enables subsequent communication (e.g., shown in the direction from the UEs to the BS, sometimes called uplink direction, shown by dashed arrows 1631, 1632, 1633) from the UEs to the BS. The UE may be, for example, a smartphone, a tablet, a mobile computer, a machine to machine (M2M) device, an Internet of Things (IoT) device, and so on.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
receiving, by a wireless device from a network node, a position reference signal;
measuring one or more parameters of the position reference signal; and
transmitting a report comprising the one or more parameters.

2. The method of claim 1, wherein the position reference signal (PRS) is communicated on a plurality of carriers, each of the plurality of carriers being associated with corresponding carrier frequency.

3. The method of claim 2, wherein the one or more parameters comprises a carrier phase and a corresponding uncertainty associated with each of the carrier frequencies.

4. The method of claim 1, wherein the position reference signal (PRS) is a downlink (DL) PRS.

5. A method of wireless communication, comprising:
transmitting, by a network node to a wireless device, a position reference signal; and
receiving, from the wireless device, a report comprising one or more parameters of the position reference signal.

6. The method of claim 5, wherein the position reference signal (PRS) is communicated on a plurality of carriers, each of the plurality of carriers being associated with corresponding carrier frequency.

7. The method of claim 6, wherein the one or more parameters comprises a carrier phase and a corresponding uncertainty associated with each of the carrier frequencies.

8. The method of claim 5, wherein the position reference signal (PRS) is a downlink (DL) PRS.

9. An apparatus for wireless communication comprising:
one or more processors, implemented in a wireless device, configured to:
receive, from a network node, a position reference signal;
measure one or more parameters of the position reference signal; and
transmit a report comprising the one or more parameters.

10. The apparatus of claim 9, wherein the position reference signal (PRS) is communicated on a plurality of carriers, each of the plurality of carriers being associated with corresponding carrier frequency.

11. The apparatus of claim 10, wherein the one or more parameters comprises a carrier phase and a corresponding uncertainty associated with each of the carrier frequencies.

12. The apparatus of claim 9, wherein the position reference signal (PRS) is a downlink (DL) PRS.

13. An apparatus for wireless communication comprising:
one or more processor, implemented in a network node, configured to:
transmit, to a wireless device, a position reference signal; and
receive, from the wireless device, a report comprising one or more parameters of the position reference signal.

14. The apparatus of claim 13, wherein the position reference signal (PRS) is communicated on a plurality of carriers, each of the plurality of carriers being associated with corresponding carrier frequency.

15. The apparatus of claim 14, wherein the one or more parameters comprises a carrier phase and a corresponding uncertainty associated with each of the carrier frequencies.

16. The apparatus of claim 13, wherein the position reference signal (PRS) is a downlink (DL) PRS.
